(19) United States
(12) Patent Application Publication
(10) Pub. No.: US 2005/0198009 A1
(43) Pub. Date: Sep. 8, 2005

(54) Method for providing data

(75) Inventors: Bernhard Bohmer, Berlin (DE); Thomas Lude, Berlin (DE); Jos Moons, Keerbergen (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/792,912

(22) Filed: Mar. 5, 2004

(51) Int. Cl. G06F 17/30

(52) U.S. Cl. 707/3

(57) ABSTRACT

The invention relates to a method for providing data relating to a user of a communication terminal (KEG2) for a querying communication terminal (KEG1). The method involves the communication terminal receiving a data query message (DAN), the data query message being used to transmit an identifier (MSISDN) for the querying communication terminal or for a user of the querying communication terminal. The communication terminal then outputs an identifier (MSISDN) for the querying communication terminal or for a user of the querying communication terminal using an output device (ANZ). The communication terminal accepts an input (G3) made following the identifier which has been output, the input providing the communication terminal with information about a group of communication subscribers with which the identifier (MSISDN) can be associated. A data store (DS) is read to determine which information types (A1, A3) are associated with this group (G3), and the querying communication terminal is then provided with the data (D) relating to the user of the communication terminal which are connected with these information types (A1, A3).

The invention relates to a method for providing data relating to a user of a communication terminal for a querying communication terminal.

Storage units in telecommunication networks are able to store a large amount of data relating to users of communication terminals. Since these data are often person-related or personal data for these users, there are occasionally reservations against unlimited provision of these data for arbitrary other communication terminals or for their users.

The invention is based on the object of specifying a method which can be used to provide data relating to a user of a communication terminal in a controlled manner.

The invention achieves this object by means of a method for providing data relating to a user of a communication terminal for a querying communication terminal, where the method involves the communication terminal receiving a data query message from the querying communication terminal, the data query message being used to transmit an identifier for the querying communication terminal or for a user of the querying communication terminal, the communication terminal then outputting an identifier for the querying communication terminal or for a user of the querying communication terminal using an output device, the communication terminal accepting an input made following the identifier which has been output, the input providing the communication terminal with information about a group of communication subscribers with which the identifier can be associated, a data store being read to determine which information types are associated with this group, and the querying communication terminal then being provided with the data relating to the user of the communication terminal which are connected (only) with these information types. A particular advantage in this context is that the querying communication terminal is provided only with such data relating to the user of the communication terminal as belong to the information types associated with the group. The input of the information about the group of communication subscribers thus makes it a simple matter to limit the volume of data to be provided and hence the data to be provided themselves.

In line with the invention, one way in which the method can proceed is for the data store to be arranged at a network node in a telecommunication network which connects the communication terminal and the querying communication terminal.

One way in which the inventive method can proceed is for the in formation about the group of communication subscribers with which the identifier can be associated to be stored in a store at the network node. This means that this information is advantageously available at the network node in the telecommunication network for later use.

In the case of the inventive method, provision of the data relating to the user of the communication terminal can involve these data being read from a storage unit at the network node. These data which are read can then be transmitted to the querying communication terminal or can be retrieved by the querying communication terminal.

Advantageously, the inventive method allows the network node used to be a presence server. Presence servers as such are already known in telecommunication networks, and the inventive method can therefore be implemented particularly easily using such presence servers.

The invention allows the output device used for the method to be a display unit on the communication terminal.

The inventive method allows the in put to be accepted using a keypad on the communication terminal. The two latter configuration options for the inventive method make it possible to use a conventional communication terminal, such as a telephone, to output the identifier to a user of this communication terminal and then to accept the input from this user.

Alternatively, one way in which the inventive method can proceed is for the input to provide the communication terminal with information about a new group of communication subscribers which is to be set up with which the identifier can be associated. This inventive configuration variant for the method makes it possible to provide the data even if no (or no suitable) group of communication subscribers has been set up yet.

One way in which the inventive method can proceed is for the information about the new group which is to be set up also to comprise the information types which can be associated with this group. This makes it possible to associate information types on a group-specific basis with this new group of communication subscribers which is to be set up.

One way in which the inventive method can proceed is for the communication terminal to transmit the information about the new group which is to be set up and information about the association between the identifier and the new group which is to be set up to the network node in order to store this information there. This means that this information is advantageously available at the network node for further use.

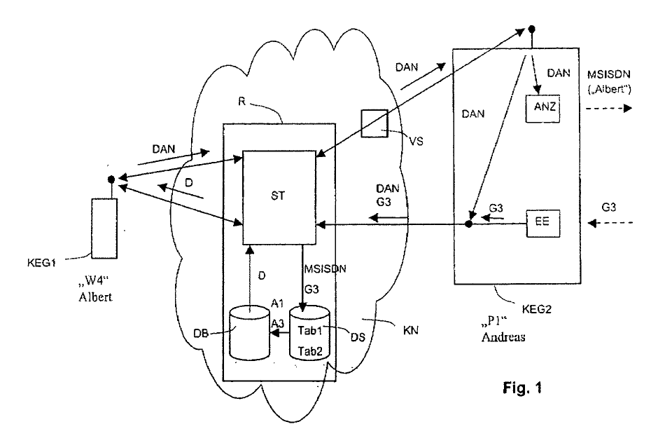

To explain the inventive method further, the text below explains exemplary embodiments of the method with reference to FIGS. 1 to 7, in which

FIG. 1 shows method steps in an exemplary embodiment of the inventive method,

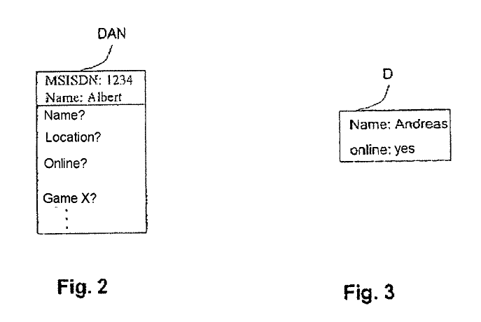

FIG. 2 shows an exemplary embodiment of a data query message,

FIG. 3 shows an exemplary embodiment of a data message,

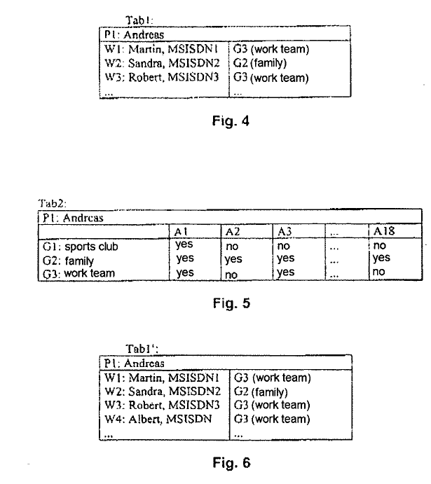

FIG. 4 shows an exemplary embodiment of a data table stored in a data store,

FIG. 5 shows an exemplary embodiment of a further data table stored in a data store,

FIG. 6 shows an exemplary embodiment of a modified data table, and

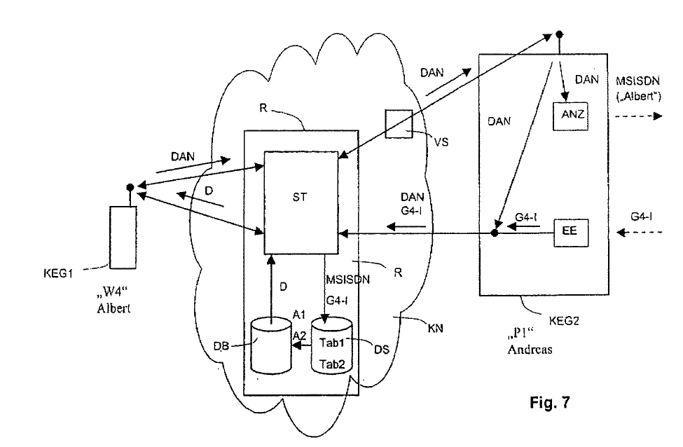

FIG. 7 shows method steps in a further exemplary embodiment of the inventive method.

FIG. 1 schematically shows a communication network KN which, by way of example, is a second or third generation mobile radio network (e.g. a GSM or GPRS mobile radio network). Of this communication network KN, only a switching center VS (mobile switching center) and a network node R in the form of a presence server are shown. Such a presence server R and a presence service, which can be provided using this presence server, as such are known, by way of example, from the specification 3GPP TS 23.141. V6.3.0 (2003-06), 3rd General Partnership Project; Technical Specification Group Services and System Aspects; Presence Service; Architecture and Functional Description (Release 6).

FIG. 1 likewise shows a communication terminal KEG1 in the form of a mobile telephone which is used by a communication subscriber “Albert”. In addition, FIG. 1 shows a communication terminal KEG2 in the form of a second mobile telephone which is used by a communication subscriber “Andreas”. The communication terminal KEG1 is intended to be used to query data relating to the user “Andreas” of the communication terminal KEG2. For this reason, the communication terminal KEG1 is also referred to as the querying communication terminal KEG1 below.

The user “Albert” of the querying communication terminal KEG1 or the querying communication terminal KEG1 is occasionally also referred to as the “watcher”. The user “Andreas” of the communication terminal KEG2 or the communication terminal KEG2 is occasionally also referred to as the “presentity”. For this reason, the communication terminal KEG2 is denoted by “P1” (=presentity 1) and the querying communication terminal KEG1 is denoted by “W4” (=“watcher 4”) in FIG. 1. The presence server R is a network node in the telecommunication network KN connecting the communication terminal KEG2 and the querying communication terminal KEG1.

At the start of the method, the querying communication terminal KEG1 sends a data query message DAN to the network node R.

FIG. 2 shows the structure of such a data query message DAN. As an identifier (identity identifier) for the querying communication terminal KEG1, the data query message DAN contains the mobile telephone number MSISDN3 (“1234”) of the querying communication terminal KEG1 (MSISDN=Mobile Station ISDN Number). In addition, the data query message DAN (optionally) contains the name “Albert” of the user of the query communication terminal KEG1. The data query message DAN is also used to transmit the information that the querying communication terminal KEG1 wishes to query the name of the user of the communication terminal KEG2, the current whereabouts of the communication terminal KEG2 or its user, and the online status of this communication terminal or its user. (Querying the online status is intended to be understood to mean a query to determine whether the communication terminal KEG2 has currently set up an active user data connection to the communication network KN, that is to say whether it is “online”. An active user data connection is not necessary for carrying out the method per se, since the data query message DAN and the further requisite information can be transmitted via permanently usable signaling channels.) In addition, the data query message DAN is used to query whether the user of the communication terminal KEG2 or his communication terminal KEG2 is taking part in a game “X” which can be played over the communication network KN. (The latter query can be made, by way of example, using freetext fields—“freetext attributes”.) The queried data are shown symbolically in the bottom part of the data query message DAN.

The specific values of the queried data are stored in a storage unit DB shown in FIG. 1 in the presence server R. As FIG. 1 shows, the data query message DAN is received by the network node R. The network node R attempts to read a table entry about the “watcher” W4 (Albert) from a data table Tab1 (described in detail below); this data table Tab1 does not yet contain such a table entry, however. For this reason, the data query message DAN is sent from the network node R to the communication terminal KEG2 via the switching center VS in the communication network KN.

The communication terminal KEG2 reads the identifier MSISDN (“1234”) from the data query message DAN. The communication terminal KEG2 then outputs an identifier for the querying communication terminal KEG1 (or an identifier for the user of the querying communication terminal KEG1) using an output device ANZ. In the exemplary embodiment, the output device ANZ is in the form of a display unit ANZ on the mobile telephone KEG2. The identifier may be, by way of example, the identifier (the mobile telephone number MSISDN) or the name (“Albert”) of the user of the querying communication terminal KEG1. If the name has not been transmitted using the data query message DAN, then the name can also be read from a telephone book store in the communication terminal KEG2 on the basis of the known mobile telephone number MSISDN.

From this identifier MSISDN, the user “Andreas” identifies that the querying communication terminal KEG1 is being used by the user “Albert”. Since the user “Albert” is a work colleague of the user “Andreas”, the identifier MSISDN can be associated with Andreas' work team G3 (which is a group of communication subscribers). Accordingly, the user “Andreas” uses an input device EE on the communication terminal KEG2 (in this exemplary embodiment uses a keypad EE on the communication terminal KEG2) to input the character string “G3” (or a different name for the group G3, e.g. the character string “work team”). This input G3 is accepted by the communication terminal KEG2, which means that the communication terminal KEG2 is provided with the information that the identifier MSISDN can be associated with the group G3 of communication subscribers (that is to say with the work team).

The communication terminal KEG2 then sends the data query message DAN together with the information about the association between the identifier and the group G3 to the network node R in the communication network (in this exemplary embodiment to the presence server R). A control unit ST in this presence server R reads the data store DS to determine which information types are associated with the group G3. For this purpose, the data store DS stores the data table Tab1 (already mentioned above), which is shown in FIG. 4.

FIG. 4 shows the data table Tab1 in the data store DS. This data table Tab1 is associated with the user “Andreas” of the communication terminal KEG2. This user “Andreas” is a first “presentity” P1 (P1=presentity 1). The data table Tab1 shows three “watchers” in the left-hand column:

| | |
|---|---|
| First “watcher” W1 | “Martin”, |
| Second “watcher” W2 | “Sandra”, |
| Third “watcher” W3 | “Robert”. |

These three communication subscribers are each clearly identifiable from an identifier in the form of their mobile telephone number MSISDN1, MSISDN2 or MSISDN3. On the right-hand side of the data table Tab1, the group of communication subscribers which is respectively associated with the identifier MSISDN1, MSISDN2 or MSISDN3 is stored. Thus, by way of example, the identifier MSISDN1 (watcher W1 “Martin”) has the associated group G3 of communication subscribers (work team). Similarly, the identifier MSISDN2 (watcher W2 “Sandra”) has the associated group G2 (family). This is because Sandra belongs to Andreas' family, and she is therefore shown as a member of the group G2 (“family”). The identifier MSISDN3 for the third watcher W3 “Robert” has the associated group G3 (work team), since Robert works with Andreas in a team. In another exemplary embodiment, it would also be possible for one identifier (one watcher) to have a plurality of associated groups.

As FIG. 1 shows, the control device ST in the presence server R stores the information about the association between the identifier MSISDN and the group G3 of communication subscribers in the store DS at the network node R . This information is entered into the data table Tab1. This produces a fourth table entry, as shown in FIG. 6 in the modified table Tab1′. The fourth table entry contains the information that the identifier MSISDN for the user “Albert” (who is the fourth watcher W4) is associated with the group G3 of communication subscribers (work team).

FIG. 5 shows a further data table Tab2, which is likewise stored in the data store DS shown in FIG. 1. This second data table Tab2 contains information about information types (A1, A2, A3, . . . to A18) respectively associated with the individual groups (G1, G2 and G3). Thus, by way of example, the first group of communication subscribers (G1: sports club) has only the first information type A1 associated with it. The second group of communication subscribers (G2: family) has all of the information types A1 to A18 associated with it. The third group G3 (work team) has the first information type A1 and the third information type A3 associated with it.

In the exemplary embodiment, the information types A1, A2, A3 and A18 have the following significance: Information type A1: name (or alias name) of the user of the communication terminal (name of the presentity) Information type A2: current whereabouts of the communication terminal or of the user of this communication terminal (location of the presentity) Information type A3: online status of the communication terminal (online status of the presenstity) Information type A18: participation in communication network game “X”.

The other information types A4 to A17 can have similar significances.

As FIG. 1 also shows, the data table Tab2 in the data store DS is read to determine which information types are associated with the group G3. In line with the data table Tab2 shown in FIG. 5, these are the information types A1 and A3 in the exemplary embodiment. This information (“A1, A3”) about the associated information types is transmitted from the data store DS to a storage unit DB in the presence server R. Subsequently, only the data relating to the user “Andreas” of the communication terminal KEG2 which are connected with these two information types A1 and A3 are provided for the querying communication terminal. This is done by reading these data from the storage unit DB in the presence server R. These data are then transmitted from the presence server R to the querying communication terminal KEG1 using a data message D.

Specifically, what is read from the storage unit DB is the data item “Name: Andreas” connected with information type A1, relating to the user “Andreas” of the communication terminal, and the data item “online: yes” connected with information type A3, relating to the user “Andreas” of the communication terminal KEG2. The further data, queried using the data query message DAN, about the location (“Location?”, information type A2) and the participation in the game X (“Game X?”, information type A18) are not read, since the group G3 merely has the associated information types A1 and A3.

The two data items read “Name: Andreas” and “online: yes” are, as shown schematically in FIG. 3, transmitted to the querying communication terminal KEG1 belonging to the watcher “Albert” using the data message D.

On the basis of the one association between the identifier MSISDN and the group G3 of communication subscribers, two different data items (name and online status) are thus provided for the query communication terminal KEG1. In another exemplary embodiment, it is naturally also possible to provide more than two different data items (that is to say a multiplicity of data items) on the basis of the one association.

FIG. 7 shows a further exemplary embodiment of the inventive method, which differs from the method illustrated in connection with FIG. 1 in that the communication terminal KEG2 accepts a specific input using the input device EE following the identifier which has been output. This specific input comprises information about a new group G4 of communication subscribers which is to be set up with which the identifier MSISDN can be associated. This new group G4 of communication subscribers which is to be set up includes, for the time being, just one communication subscriber, namely the communication subscriber “Albert”.

The information about the new group G4 which is to be set up is referred to as “G4 information” G4-I in FIG. 7. This G4 information G4-I reveals that the new group G4 which is to be set up is a skittles club and that this group G4 has the associated information types A1 and A2. The information G4-I about the new group G4 of communication subscribers which is to be set up thus comprises the information types A1 and A2 which can be associated with this group.

The communication terminal KEG2 transmits the information about the new group which is to be set up in the form of the G4 information G4-I and also additionally the input information about the association between the identifier MSISDN and the new group G4 which is to be set up to the network node R. The information G4-I about the new group G4 which is to be set up is then stored in the second data table Tab2; the information about the association between the identifier MSISDN and the new group G4 which is to be set up is stored in the first data table Tab1. Hence, the data store DS in the presence server R has been extended by a new group of communication subscribers and by a new association between an identifier and the new group of communication subscribers. (The association between the identifier and the new group which is to be set up may also be referred to as classification of the identifier into the new group which is to be set up.)

In the case of the method described, it is particularly advantageous that the association, stored in the data store DS, between information types and groups of communication subscribers means that only a relatively small number of information items needs to be accepted by the communication terminal KEG2 during the input. If there is already a suitable group for the querying communication terminal KEG1 (which can be identified by the identifier) or for its user and this group is stored in the data table Tab2 in the data store DS, then the communication terminal KEG2 needs to accept only a single information item during the input: namely information about the one group of communication subscribers which can be associated with the identifier. In the case of the inventive method, it is thus advantageously possible to take the one association between this group of communication subscribers and the identifier as a basis for providing the data.

Should no suitable group be stored in the data store DS, then the communication terminal KEG2 needs to accept just a small number N of information items during the input, where it holds true that: N=(number of different information type s+1). The reason for this is that, for the one new group which is to be set up, it is merely necessary to input for each of the information types whether this information type is associated with the new group which is to be set up (“yes” in a second data table Tab2) or is not associated therewith (“no” in the second data table Tab2). The information about the new group which is to be set up itself (e.g. “group G4”) is the information “+1”. As soon as the information about the new group of communication subscribers which is to be set up is stored in the data store, a maximum of a single input (e.g. “G4”) is required for a data query message from a member of this group which has been set up. The result is a method for providing data relating to a user of a communication terminal which is extremely simple to carry out and convenient.

1. A method for providing data relating to a user of a communication terminal (KEG2) for a querying communication terminal (KEG1), where the method involves
the communication terminal (KEG2) receiving a data query message (DAN), the data query message (DAN) being used to transmit an identifier (MSISDN) for the querying communication terminal (KEG1) or for a user of the querying communication terminal (KEG1),
the communication terminal (KEG2) then outputting an identifier (MSISDN) for the querying communication terminal (KEG1) or for a user of the querying communication terminal (KEG1) using an output device (ANZ),
the communication terminal (KEG2) accepting an input (G3) made following the identifier which has been output, the input providing the communication terminal (KEG2) with information about a group of communication subscribers (G3) with which the identifier (MSISDN) can be associated,
a data store (DS) being read to determine which information types (A1, A3) are associated with this group (G3), and
the querying communication terminal then being provided with the data (D) relating to the user of the communication terminal which are connected with these information types (A1, A3).

2. The method as claimed in claim 1, characterized in that
the data store (DS) is arranged at a network node (R) in a telecommunication network (KN) which connects the communication terminal (KEG2) and the querying communication terminal (KEG1).

3. The method as claimed in claim 2, characterized in that
the information about the group of communication subscribers (G3) with which the identifier (MSISDN) can be associated is stored in a store (DS) at the network node (R).

4. The method as claimed in claim 1, characterized in that
provision of the data (D) relating to the user of the communication terminal involves these data (D) being read from a storage unit (DB) at the network node (R).

5. The method as claimed in claim 2, characterized in that
the network node used is a presence server (R).

6. The method as claimed in claim 1, characterized in that
the output device used is a display unit (ANZ) on the communication terminal (KEG2).

7. The method as claimed in claim 1, characterized in that
the input is accepted using a keypad (EE) on the communication terminal (KEG2).

8. The method as claimed in claim 1, characterized in that
the input provides the communication terminal (KEG2) with information (G4-I) about a new group of communication subscribers which is to be set up with which the identifier (MSISDN) can be associated.

9. The method as claimed in claim 8, characterized in that
the information (G4-I) about the new group which is to be set up also comprises the information types (A1, A2) which can be associated with this group.

10. The method as claimed in claim 8, characterized in that
the communication terminal (KEG2) transmits the information (G4 -I) about the new group which is to be set up and information about the association between the identifier (MSISDN) and the new group which is to be set up to the network node (R) in order to store this information there.
